(19) United States
(12) Patent Application Publication
(10) Pub. No.: US 2002/0048658 A1
(43) Pub. Date: Apr. 25, 2002

(54) Recording sheet

(75) Inventors: Jun Takahashi, Tochigi (JP); Akio Ito, Tochigi (JP); Yukiko Murasawa, Tochigi (JP); Hideaki Takahashi, Tochigi (JP)

Correspondence Address: HOGAN & HARTSON LLP, 555 13th Street, N.W., Washington, DC, 20004, US

(73) Assignee: Sony Chemicals Corporation

(21) Appl. No.: 09/886,466

(22) Filed: Jun. 22, 2001

(30) Foreign Application Priority Data
Jun. 22, 2000 (JP) P.2000-187879

(51) Int. Cl. B41M 5/00

(52) U.S. Cl. 428/195

(57) ABSTRACT

A recording sheet is provided, which difficultly undergoes handing of printed images formed thereon and which can permit to print with a pigment ink. In the recording sheet of the invention, an ink-permeable layer contains a filler and a surfactant of 9.0 or less in HLB value and surface of the filler particles is in a state of being covered with lipophilic groups of the surfactant, and thus an ink applied to the surface of the ink-permeable layer does not spread on the surface of the ink-permeable layer but is absorbed into the ink-permeable layer and, in the ink-permeable layer, the ink does not diffuse in the surface direction but migrates straight in the depth direction. Further, addition of a cation group-containing compound as a fixing agent to the ink-receiving layer of the recording sheet serves to improve fixing properties of the colorant in the ink-receiving layer, thus no banding occurring within the ink receiving layer as well.

### BACKGROUND OF THE INVENTION

1. Field of the Invention

This invention relates to a recording sheet for use in, for example, recording with an ink and, more particularly, to a recording sheet for use in an ink jet printer.

2. Description of the Related Art

As an output printer for a computer or a word processor, there have so far been used printers of various systems such as wire dot recording system, thermal color-forming recording system, thermal melt transfer recording system, thermal sublimation transfer recording system, electrophotographic recording system or ink jet recording system.

Of these systems, ink jet recording system has excellent advantages. For example, it permits to use woodfree paper as a recording sheet and, in comparison with other recording systems, it forms printed products with less cost, generates less noise upon printing, uses a smaller printing apparatus, and forms printed products at a higher speed. Thus, in recent years the ink jet recording system has found rapidly increasing applications.

As recording sheets to be used for the ink jet recording system, various recording sheets have been proposed.

Sign 110 in FIG. 9A shows one example of a recording sheet to be used for the ink jet recording system.

This recording sheet 110 has a transparent substrate 111, an ink-recording layer 112 formed on the surface of the substrate 111, and an ink-permeable layer 113 formed on the surface of the ink-recording layer 112.

In conducting ink jet recording on the recording sheet 110, an ink 114 is ejected toward the surface of the ink-permeable layer 113 through nozzles of the ink jet printer. (FIG. 9A)

To the ink-permeable layer 113 of the recording sheet 110 is generally added an inorganic or organic filler, etc. The filler particles dispersed in a resin used as a binder in the ink-permeable layer 113 form gaps between them, thus forming a porous structure within the ink-permeable layer 113.

The ink 114 deposited on the surface of the ink permeable layer 113 passes through the voids of this porous structure to the interior of the ink-permeable layer 113.

The ink 114 permeating to the interior of the ink-permeable layer 113 further migrates in the depthwise direction and, when reaching the ink-receiving layer, is absorbed by the ink-receiving layer 112.

The ink absorbed in the ink-receiving layer 112 is observed as dots 117 from the ink-receiving layer 112-free side of the transparent substrate 111, an aggregate of these dots 117 being viewed as a printed image (FIG. 9B).

In recent years, such recording sheet 110 has been popularly used for overhead projectors or advertisement of electric decoration.

In addition, as is described in JP-A-62-280068, addition of a surfactant to the ink-permeable layer 113 serves to more improve ink permeability of a dye ink using a dye as a colorant.

However, as is different from dyes existing in a dissolved state in an ink, pigments used as a colorant in an ink exist as particles and difficultly permeate into the ink-permeable layer 113, thus being stayed within the ink permeable layer.

As a result, quantity of the colorant to be absorbed by the ink receiving layer 112 is decreased, leading to a decrease in print density of an image (reflected image) viewed from the side of the surface of substrate 111.

This recording sheet 110 contains a hydrophobic organic filler in the ink-permeable layer 113. However, such organic fillers are generally more expensive than inorganic fillers, and lead to an increase in the cost of producing the whole recording sheet 110.

Although it may be easily devised to use inexpensive silica in place of the expensive hydrophobic organic fillers, silica surface is covered with hydrophilic groups such as silanol group and therefore has an affinity for an aqueous ink. Hence, an aqueous ink generally used for ink jet printers permeates not only in a depthwise direction but in a level direction as well within the ink-permeable layer 113, thus diffusing within the ink permeable layer 113.

Wide diffusion of inks causes mixing of the different inks 114 with each other within the ink-permeable layer 113 and, as a result, dots 117 of the printed image overlap each other, the overlapped portions being viewed as banding of the printed image.

### SUMMARY OF THE INVENTION

The present invention has been made for solving the problem with the related art and provides an art of producing a recording sheet which scarcely produces banding in printed images.

The recording sheet of a first aspect of the present invention comprises: an ink-receiving layer capable of holding an ink; and an ink-permeable layer provided on the surface of the ink-receiving layer and permeating the ink therethrough to transport the ink to the ink-receiving layer, wherein the ink-permeable layer comprises a surfactant having an HLB value of 9 or less.

### BRIEF DESCRIPTION OF THE DRAWINGS

FIGS. 1A to 1C are diagrams showing the steps of the invention.

FIG. 2 is a diagram illustrating the state of dots using yellow inks.

FIG. 3 is a diagram illustrating the state of dots using cyan inks.

FIG. 4 is a diagram illustrating the state of dots using magenta inks.

FIG. 5 is a diagram showing one example of printed image with banding.

FIG. 6 is a diagram showing another example of printed image with banding.

FIG. 7 is a diagram illustrating the state of an image printed on the recording sheet of the invention.

FIG. 8 is a diagram illustrating the state of filler particle surface.

FIG. 9A and 9B are diagrams illustrating a recording sheet of the related art.

In these figures, numeral 10 designates a recording sheet; 11 a substrate; 12 an ink-receiving layer; and 13 an ink-permeable layer.

### DETAILED DESCRIPTION OF THE INVENTION

Firstly, HLB value of a surfactant, employed as a constituent of the invention, is described below.

Surfactants are substances which have both hydrophilicity and lipophilicity (oleophilicity) and, in order to quantitatively show the relation between the lipophilicity and the hydrophilicity, a value called HLB (Hydrophilic-Lipophilic Balance) is generally used.

HLB values of surfactants are determined empirically from the results of many emulsification experiments, and are known to almost coincide with the values obtained by calculation based on chemical structure of the surfactants.

There are various methods for calculating HLB values from chemical structure. Of these methods, a formula for calculating HLB value employed in the invention and group numbers of typical hydrophilic groups and lipophilic groups to be used in the formula are shown by the following formula (1) and Table 1, respectively.

HLB=7+Σ(group number of hydrophilic group)+Σ(group number of lipophilic group) (1)

TABLE 1
Group numbers of hydrophilic groups and lipophilic groups

| | | Group Number |
|---|---|---|
| Hydrophilic Group | Ester (sorbitan ring) | 6.8 |
| | Ester | 2.4 |
| | —COOH | 2.1 |
| | —OH | 1.9 |
| | —O— | 1.3 |
| | —OH (sorbitan ring) | 0.5 |
| Lipophilic group | —CH— | −0.475 |
| | CH₂— | |
| | —CH₃ | |
| | —CH— | |
| Derived group | (CH₂—CH₃O) | 0.33 |
| | 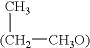 | −0.15 |

From the above formula (1), it is seen that the HLB value demonstrates additivity of the various group numbers in stoichiometric meaning, and hence, the more the number of lipophilic groups showing a group number of minus value, the smaller the HLB value. On the contrary, the more the number of hydrophilic groups, the more the HLB value.

Table 2 below shows HLB values of surfactants suited for dispersing various oils in water (HLB values required for dispersing the oils).

TABLE 2
HLB values required for dispersing oils

| | Required HLB |
|---|---|
| Cotton seed oil | 7.5 |
| Carbon tetrachloride | 9 |
| Paraffin wax | 9 |
| Microcrystalline wax | 9.5 |
| Mineral oil (light) | 10 |
| Mineral oil (heavy) | 10.5 |
| Silicone oil | 10.5 |
| Kerosine | 12.5 |
| Cetyl alcohol | 13 |
| Naphtha | 13 |
| Bees wax | 10 to 16 |
| Carnauba wax | 14.5 |
| Anhydrous lanolin | 15 |
| Dimethyl phthalate | 15 |
| o-Phenylphenol | 15.5 |
| Stearic acid | 17 |

As is shown in Table 2 above, surfactants having a higher HLB value are suited for oils having a higher polarity (higher hydrophilicity), whereas surfactants having a lower HLB value are suited for oils having a lower polarity (higher lipoophilicity). Thus, there is such tendency that, the lower the HLB value, the lower the affinity for substances having a high hydrophilicity.

The invention is constituted by using the HLB value described above, and the invention described in claim 1 is a recording sheet having an ink-receiving layer which can retain an ink, and an ink-permeable layer which is provided on the surface of the ink-receiving layer and which permeates the ink therethrough to thereby transport the ink to the ink-receiving layer, the ink-permeable layer containing a surfactant of 9 or more in the HLB value.

The ink-permeable layer may contain an inorganic filler such as calcium carbonate, titanium oxide, calcium hydroxide or silica.

A second aspect of the present invention is the recording sheet according to the first aspect, wherein the ink-permeable layer contains a water-insoluble resin.

A third aspect of the present invention is the recording sheet according to the second aspect, wherein the water insoluble resin is polyester.

A fourth aspect of the present invention is the recording sheet according to one of the first to third aspects, wherein the ink-receiving layer contains a cation group-having compound as a fixing agent.

A fifth aspect of the present invention is the recording sheet according to the fourth aspect, wherein the cation group-having compound is a cation group-containing resin.

A sixth aspect of the present invention is the recording sheet according to the fourth or fifth aspect, wherein the ink-receiving layer contains a hydrophilic fixing aid comprising a resin different from the fixing agent.

The invention is constituted as described above, and a surfactant having an HLB value of 9.0 or less is added to the ink-permeable layer of the recording sheet of the invention.

Various inorganic fillers may be added to the ink-permeable layer of the invention but, in view of foundation effect and cost, silica is preferred.

Numeral 50 in FIG. 8 designates filler particles comprising silica. Hydrophilic groups such as silanol groups 52 or siloxane 55 are laid bare on the surface of the filler particles 50, and the filler particles 50 in this state show a high hydrophilicity.

In the invention, a surfactant having an HLB value of 9.0 or more is added to the ink-permeable layer, and the silanol groups 52 or siloxane 55 are bound to the hydrophilic group of the surfactant, thus surface of filler particles 50 being covered with the lipophilic group of the surfactant. In this state, hydrophilicity and water absorbing ability of the filler particles 50 existing within the ink-permeable layer are depressed.

Signs 20₁ to 20₃ in FIGS. 5 show recording sheets in which an ink-permeable layer 23 containing the filler particles 50 is formed on the surface of an ink-receiving layer 22 formed on a substrate 21 comprising a resin film.

In these recording sheets 20₁ to 20₃, ink droplets 40 deposit on the surface of the ink-permeable layer 23, permeate through the ink-permeable layer 23, and absorbed within the ink-receiving layer 22, thus reaching to the backside of the substrate 21. Thus, in viewing from the side of the surface of the ink-permeable layer or from the side of substrate 21, dots 25a and 25b formed by the ink remaining on the surface of the ink-permeable layer 23 or 26a and 26b formed by the ink having reached the backside of the substrate 21 are viewed.

The ink-permeable layer 23 of the recording sheet 20, shown in FIG. 5 does not contain a surfactant having an HLB value of 9.0 or less and surface of the filler contained in the ink-permeable layer 23 shows hydrophilicity. Hence, the deposited aqueous ink 40 difficultly permeates in the depthwise direction and seriously diffuses in a lateral directiion. As a result, dots 25a and 25b on the surface of the ink-permeable layer 23 overlap each other.

Sign 27 in FIG. 5 shows the portion where dots 25a and 25b overlay each other. Color mixing or difference in density takes place in the portion 27. Hence, when viewing the recording sheet 20₁ from the substrate 21 side, streaks are viewed in the direction in which the head of ink jet printer runs. That is, when the recording sheet 20₁ is irradiated with light and viewed from the side opposite to the light-irradiating side as a transmitted image, unfavorable banding of the image is viewed.

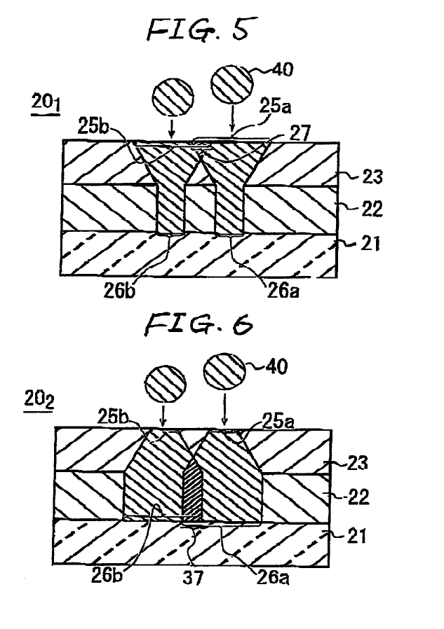

On the other hand, the recording sheet 20ₐ in FIG. 6 shows the case wherein, though diffusion in the lateral direction on the surface of the ink-permeable layer 23 is decreased to some extent by combination of a resin constituting the ink-permeable layer and the filler, the ink diffuses in the lateral direction at the interface between the substrate 21 and the ink-receiving layer 22 in case when quantity of the ink 40 is too much for the area of the dots 25a and 25b formed in the ink-permeable layer 23 or when the ink-receiving layer 22 has an insufficient ink-absorbing volume, thus the ink overlapping within the ink-permeable layer 23 and the ink-receiving layer 22 to form the overlapping portion 37 of the dot 26a and 26b at the interface between the substrate 21 and the ink-receiving layer 22.

That is, in this recording sheet 20₂, banding is caused not only in the transmitted image as described above but in the image (reflected image) to be viewed from the light-irradiating side when light is irradiated toward the substrate 21.

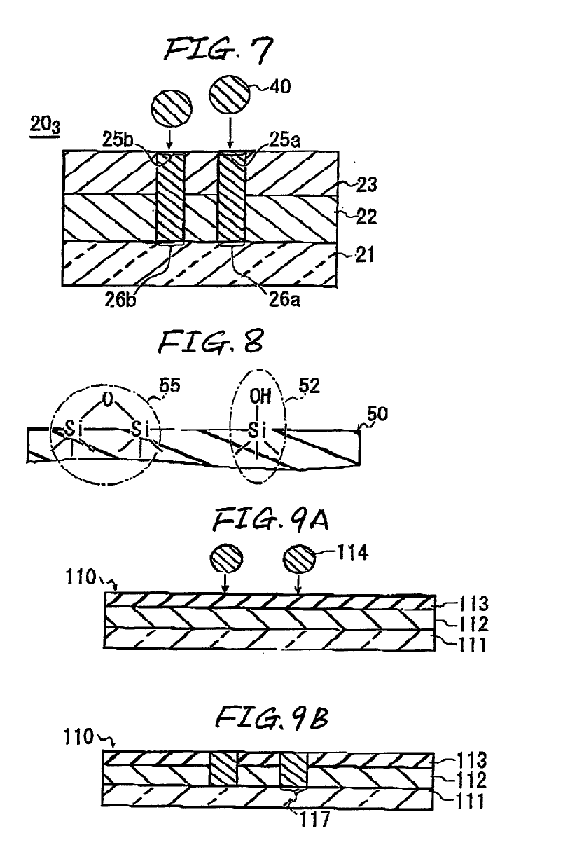

Sign 20₃ in FIG. 7 shows the state of a recording sheet o fthe invention after being printed, wherein an aqueous ink vertically permeates through the ink-permeable layer 23 since the surface of inorganic filler contained in the ink-permeable layer 23 has suitable hydrophilicity and lipophilicity.

Use of the ink-receiving layer 22 having a large ink-absorbing volume serves to form no overlaps of the dots 25a and 25b formed on the surface of the ink-permeable layer 23 and no overlaps of the dots 26a and 26b formed on the interface between the substrate 21 and the ink-receiving layer 22 as well. That is, in this recording sheet 20₃, no bandings were observed either in the transmitted image or in the reflected image.

The invention is now described more specifically by reference to Examples which, however, are not be construed as limitative at all.

### EXAMPLES

An embodiment of the recording sheet of the invention is illustrated together with its production steps using drawings.

First, to 40 parts by weight of a cation group containing resin (cation-modified urethane resin of “IJ60” (trade name; manufactured by DAINIPPON INK AND CHEMICALS, INCORPORATED.) containing 15% by weight of solids being used) were added 6 parts by weight of a water-soluble resin of polyvinyl pyrrolidone (“Luviscol K90” manufactured by BASF), 3 parts by weight of aluminum hydroxide (“H42”; trade name; manufactured by Showa Denko K. K.) and 51 parts by weight of ion-exchanged water, and the resulting mixture was stirred for 3 hours in a jar mill to obtain a coating solution for forming an ink-receiving layer.

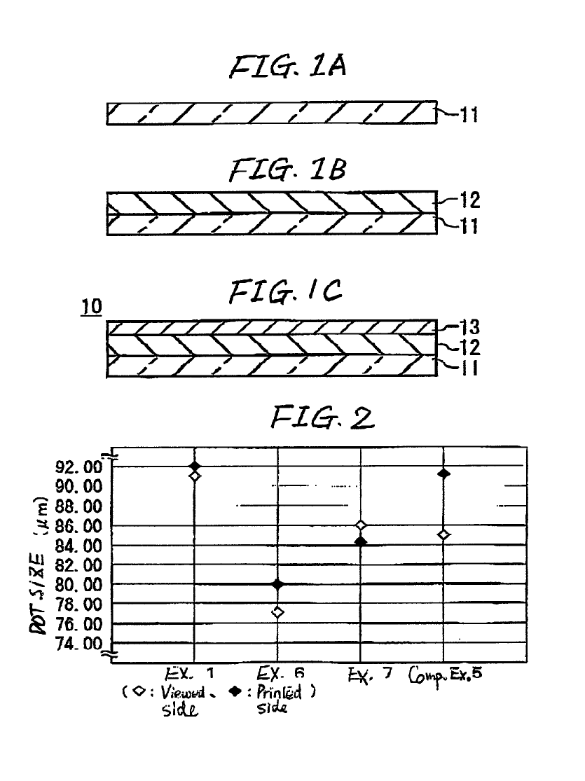

Numeral 11 in FIG. 1A designates a transparent substrate comprising a polyethylene terephthalate resin (a product with a trade name of “Cosmo Shine A4100” manufactured by Toyobo Co., Ltd. being used here). On the surface of this substrate 11 was coated the coating solution for forming an ink-receiving layer prepared in the above step using a bar coater, then dried in a hot air-circulating oven at 120° C. for 3 minutes to form an ink receiving layer 12 (FIG. 1B). Here, the ink-receiving layer 12 was formed so that its thickness after being dried became 13 μm.

Then, 14 parts by weight of cyclohexane was added to 56 parts by weight of methyl ethyl ketone to prepare a solvent. 15 parts by weight of a water insoluble resin of polyester resin (trade name: “Vylon 200”; made by TOYOBO Co., Ltd.) was added to the solvent under stirring in a dissolver, followed by stirring for 2 hours to prepare a resin solution wherein the polyester resin was dissolved in the solvent).

To this resin solution were added 15 parts by weight of an inorganic filler of silica gel (trade name: “Mizukasil P527”; manufactured by Mizusawa Industrial Chemicals, Ltd.) and 2.5 parts by weight of sorbitan triolcate (trade name: “OP 05R”; HLB: 1.8 manufactured by NOF Corporation), followed by stirring for further 1 hour to prepare a coating solution for forming an ink-permeable layer.

Then, the coating solution for forming an ink-permeable layer prepared in the above-described step was coated on the surface of the ink-receiving layer 12 in a state shown in FIG. 1B, and the whole was dried at 120° C. for 3 minutes using a hot air-circulating oven to form an ink-permeable layer 13 containing silica as an inorganic filler.

Numeral 10 in FIG. 1C designates a recording sheet having formed on the surface thereof the ink-permeable layer 13. Here, the ink-permeable layer 13 was formed so that its thickness after being dried became 12 μm (FIG. 1C).

Numer 10 in FIG. 1C designates a recording sheet wherein an ink-permeable layer 13 is formed.

This recording sheet 10 was used in Example 1, in which a predetermined print image (wherein 8 patterns of human figures were in a line in a lateral direction in an A4 size) was printed on the surface of the ink-permeable layer 13 of the recording sheet using an ink jet printer (trade name: “FJ 40”; made by Roland) loaded with a pigment ink to thereby prepare a test piece.

“Print density” and “transmitted image banding” were evaluated, respectively, using this test piece.

[Print Density]

The thus printed image was visually observed (as reflected image) at a distance of 30 cm from the recording sheet 10 from the side on which the ink-receiving layer 12 and the ink-permeable layer 13 were not formed on the substrate 11.

In this occasion, an image with a high color density is rated as “GOOD”, and an image with a low color density as “POOR”. Results thus obtained are tabulated in the following Table 3.

[Banding in Transmitted Image]

The recording sheet was placed on a light source of a light box (trade name: “Fiji Color Light Box 50000 Inverter”; made by Fuji Photo Film Co., Ltd.) with the ink-permeable side 13 facing downward, and an image (transmitted image) lighted up by the light box was visually checked for banding.

Visual observation was conducted changing the distance between the recording sheet 10 and the position of visual observation, and an image with which no banding was visually confirmed even at a distance shorter than 30 cm was rated as “GOOD”, and an image with which no banding was visually confirmed at a distance of 30 cm or more as “POOR”. Results of these are shown in Table 3.

TABLE 3
Evaluation test

| | | | | | Banding of |
|---|---|---|---|---|---|
| | | | | Print | Transmitted |
| | Surfactant | Composition | HLB | Density | Image |
| Ex. 1 | OP-85R | Sorbitan | 1.8 | GOOD | GOOD |
| | | trioleate | | | |
| Ex. 2 | E-202S | POE (2) | 4.9 | GOOD | GOOD |
| | | oleyl ether | | | |
| Ex. 3 | OP-3 | POE (2) octyl | 6.0 | GOOD | GOOD |
| | | phenyl ether | | | |
| Ex. 4 | BC-2 | POE (2) cetyl | 8.0 | GOOD | GOOD |
| | | ether | | | |
| Ex. 5 | S-2 | POE (2) | 8.0 | GOOD | GOOD |
| | | stearate | | | |
| Ex. 6 | E-205S | POE (5) | 9.0 | GOOD | GOOD |
| | | oleyl ether | | | |
| Ex. 7 | TAMNO-5 | POE (5) | 9.0 | GOOD | GOOD |
| | | oleyl amine | | | |
| Com. | S-4 | POE (4) | 11.6 | GOOD | POOR |
| Ex. 1 | | stearate | | | |
| Com. | S-206 | POE (6) | 9.9 | POOR | POOR |
| Ex. 2 | | Stearyl ether | | | |
| Com. | E 230 | POE (30) | 16.6 | POOR | GOOD |
| Ex. 3 | | oleyl ether | | | |
| Com. | OP-10 | POE (10) | 11.5 | GOOD | POOR |
| Ex. 4 | | octyl-phenyl | | | |
| | | ether | | | |
| Com. | none | — | — | GOOD | POOR |
| Ex. 5 | | | | | |

In the above table, POE represents polyoxyethylene, and numbers in the parentheses show numbers of POE per molecule of respective compounds.

### EXAMPLES 2 to 7

The inorganic filler used in Example 1 and each of the surfactants having an HLB of 9.0 or less shown in the above Table 3 were mixed with the resin solution prepared in the same step as in Example 1 in the same proportions as shown in Example 1, followed by conducting the same steps as in Example 1 to prepare coating solutions for forming an ink-permeable layer which contained varying kinds of surfactants.

In Examples 2 to 7, each of these coating solutions for forming an ink-permeable layer was coated on the surface of the ink-receiving layer 12 shown in FIG. 1B in the same step as in Example 1, then dried to respectively form ink-permeable layers 13 containing varying kinds of surfactants.

As the varying kinds of surfactants, polyoxyethylene (hereinafter abbreviated as “POE”) (2) oleyl ether having an HLB value of 4.9 (trade name: “E-202S”; manufactured by NOF Corporation) was used in Example 2, POE (2) octylphenyl ether having an HLB value of 6 (trade name: “OP-3”; manufactured by Nikko Chemicals Co., Ltd..) was used in Example 3, POE (2) cetyl ether having an HLB value of 8 (trade name: “BC-2”; manufactured by Nikko Chemicals Co., Ltd..) was used in Example 4, POE (2) stearate having an HLB value of 8 (trade name: “S-2”; manufactured by NOF Corporation) was used in Example 5, POE (5) oleyl ether having an HLB value of 9 (trade name: “E-205S”; manufactured by NOF Corporation) was used in Example 6 and, POE (5) oleylamine having an HLB value of 9 (trade name: “TAMNO-5”; manufactured by Nikko Chemicals Co., Ltd..) was used in Example 7.

These recording sheets 10 prepared in Examples 2 to 7 were subjected to the same steps as in Example 1 to form a printed image, thus test pieces being obtained. These test pieces were subjected to the tests on “print density” and “banding of transmitted image” under the same conditions as in Example 1. Results of the evaluation are shown in Table 3.

### COMPARATIVE EXAMPLES 1 to 4

The inorganic filler used in Example 1 and each of the surfactants having an HLB of 9.1 or more shown in the above Table 3 were mixed with the resin solution prepared in the same step as in Example 1 in the same proportions as shown in Example 1, followed by conducting the same steps as in Example 1 to prepare coating solutions for forming an ink-permeable layer which contained varying kinds of surfactants.

In Comparative Examples 1 to 4, each of these coating solutions for forming an ink-permeable layer was coated on the surface of the ink-receiving layer 12 shown in FIG. 1B in the same step as in Example 1, then dried to respectively form ink-permeable layers 13 containing a surfactant having an HLB value of 9.1 or more.

As the surfactants having an HLB value of 9.1 or more, POE (4) stearate having an HLB value of 11.6 (trade name: “S-4”; manufactured by Nikko Chemicals Co., Ltd..) was used in Comparative Example 1, POE (6) stearyl ether having an HLB value of 9.9 (trade name: “S-206”; manufactured by NOF Corporation) was used in Comparative Example 2, POE (30) oleyl ether having an HLB value of 16.6 (trade name: “E-230”; manufactured by NOF Corporation) was used in Comparative Example 3, and POE (10) octylphenyl ether having an HLB value of 11.5 (trade name: “OP-10”; manufactured by Nikko Chemicals Co., Ltd..) was used in Comparative Example 4.

### COMPARATIVE EXAMPLE 5

15 parts by weight of the inorganic filler used in Example 1 was added to 70 parts by weight of the resin solution prepared in the same step as in Example 1, followed by conducting the same steps as in Example 1 to prepare a coating solution for forming an ink permeable layer containing no surfactants.

In Comparative Example 5, this coating solution for forming an ink-permeable layer was coated on the surface of the ink-receiving layer shown in FIG. 1B in the same step as in Example 1, then dried to form an ink-permeable layer containing no surfactants.

These recording sheets 10 prepared in Comparative Examples 1 to 5 were subjected to the same steps as in Example 1 to form a printed image, thus test pieces being obtained. These test pieces were subjected to the tests on “print density” and “banding of transmitted image” under the same conditions as in Example 1. Results of the evaluation are shown in Table 3.

It was confirmed, by reference to Table 3, that no banding was observed in the transmitted images formed in Examples and that banding was observed in Comparative Examples 1, 2, 4 and 5. It was also confirmed that the recording sheets 10 of Examples 1 to 7 showed higher ink permeability than the recording sheets of Comparative Examples 1, 2, 4, and 5 thus the ink vertically permeating through the ink-permeable layer 13 of Examples 1 to 7.

Excellent results were obtained in Examples 1 to 7 with respect to “print density” as well. In Comparative Examples 2 and 3, however, color density of the image (reflected image) viewed from the side of the substrate on which side the ink receiving layer and the ink-permeable layer were not formed was low. This may be because the pigment particles used as colorant of pigment ink have a larger particle size in comparison with dyes, and hence permeability of the ink used in Comparative Examples 2 and 3 was so poor that pigment particles remained within the ink permeable layer and failed to fully reach the interface between the ink-receiving layer and the substrate.

### EXAMPLES 8 to 15

The same silica and the same surfactant as used in Example 1 were added in amounts (parts by weight) respectively shown in Table 4 to 70 parts by weight of the resin solution prepared under the same condition as in Example 1, followed by conducting the same steps as in Example 1 to prepare 8 kinds of coating solutions for forming an ink-permeable layer different in the added amount (parts by weight) of the surfactant.

In Examples 8 to 15, each of these coating solutions for forming an ink-permeable layer was coated on the surface of the ink receiving layer 12 shown in FIG. 1B in the same step as in Example 1, then dried to respectively form recording sheets 10 as shown in FIG. 1C.

These recording sheets 10 were subjected to the tests on “print density” and “banding of transmitted image” under the same conditions as in Example 1 and, further, on “coating adhesion test” shown below.

[Coating Adhesion Test]

A print sample was printed on the surface of the recording sheet 10 under the same conditions as in Example 1, and an adhesive side of a transparent adhesive tape was applied to the print sample-printed side (ink-coated side) of the ink-permeable layer 13, followed by peeling the tape.

Ink-permeable layer 13 not undergoing peeling off at the transparent adhesive tape-applied portion was rated as “GOOD”, that undergoing peeling off partly (the case where while the ink-permeable layer remained on the ink-receiving layer, it also attached to the tape) rated as “FAIR”, and that undergoing peeling off from the ink-receiving layer perfectly was rated as “POOR”. Results of these evaluations are shown in the following Table 4.

TABLE 4
Evaluation Tests

| | Added Amount | | Banding of | |
|---|---|---|---|---|
| | (parts by | Print | transmitted | Coating |
| | weight) | Density | image | Adhesion |
| Ex. 8 | 0.5 | POOR | POOR | GOOD |
| Ex. 9 | 1 | FAIR | GOOD | GOOD |
| Ex. 10 | 3 | GOOD | GOOD | GOOD |
| Ex. 11 | 5 | GOOD | GOOD | GOOD |
| Ex. 12 | 10 | GOOD | GOOD | GOOD |
| Ex. 13 | 20 | GOOD | GOOD | GOOD |
| Ex. 14 | 30 | GOOD | GOOD | FAIR |
| Ex. 15 | 40 | FAIR | POOR | POOR |

As is shown in Table 4, it is confirmed that, in the invention, when the surfactant is added in an amount of from 1 part by weight to 30 parts by weight, recording sheets 10 showing excellent printing quality and having tough image-permeable layer 13 are obtained.

### EXAMPLES 16 to 22

Other examples of the recording sheet 10 of the invention are described below.

First, a resin solution was prepared using a hydrophilic resin different from that used in Examples 1 to 15 (i.e., a modified urethane resin containing catiion groups (trade name: “IJ50”; made by DAINIPPON INK AND CHEMICALS, INCORPORATED.)), which was used as a coating solution for forming an ink-receiving layer.

This coating solution for forming an ink-receiving layer was coated in the same step on the surface of substrate 11 shown in FIG. 1A, followed by drying to form an ink-permeable layer 13, thus a recording sheet 10 being obtained (Example 16).

In addition, 6 kinds of coating solutions for forming an ink-receiving layer were prepared respectively using, in place of the modified urethane resin used in the above Example 16, 6 kinds of resins, i.e., a modified polyvinyl alcohol (trade name: “CM318”; made by Kurarey Co., Ltd.), an acryl copolymer (trade name; “IJAP480”; made by Osaka Organic Chemical Ind. Co., Ltd.), a water-soluble polyester (trade name: “NS122L; made by TAKAMATSU OIL & FAT CO., LTD.), a polyvinyl alcohol having a saponification degree of 99 (trade name; “PVA117”; made by Kurarey Co., Ltd.), a modified polyvinyl alcohol (trade name: “KM118”made by Kurarey Co., Ltd.) and a water-soluble polyester different from the above-described water-soluble polyester (trade name: NS300L”, made by TAKAMATSU OIL & FAT CO., LTD.).

The ink-receiving layer 12 was formed on the surface of the substrate 11 according to the above-described step using each of these coating solutions for forming an ink-receiving layer, then the same ink-permeable layer 13 as in Example 1 was formed on the ink-receiving layer 12 to prepare respective recording sheets 10 (Examples 17 to 22).

Print images were formed under the same conditions as in Example 1 using these recording sheets 10 of Examples 16 to 22 to prepare respective test pieces.

These test pieces were used for the following evaluation tests on “banding of transmitted image” and “banding of reflected image”.

[Banding of Transmitted Image]

Banding of transmitted image formed on each of the test pieces was checked by visual observation under the same conditions as employed with respect to “banding of transmitted image” in Examples 1 to 15.

Here, visual observation was conducted changing the distance between the recording sheet 10 and the position of visual observation, and an image with which no banding was visually confirmed even at a distance shorter than 30 cm was rated as “GOOD”, an image with which banding was visually confirmed at a distance shorter than 30 cm but no banding was visually confirmed at a distance of 30 cm to shorter than 1 m was rated as “FAIR”, and an image with which no banding was visually confirmed at a distance of 30 cm or more as “POOR”. Results of these are shown in Table 5.

[Banding of Reflected Image]

Each of the print images formed on the test pieces was visually observed under room light from the side of the recording sheet 10 on which side the ink-receiving layer 12 and the ink-permeable layer 13 were not formed, and banding of the image (reflected image) was visually confirmed. Here, visual observation was conducted at a distance 30 cm spaced from the recording sheet 10.

A reflected image with which no banding was confirmed was rated as “GOOD”, and that with which banding was confirmed was rated as “POOR”. Results thus obtained are shown in Table 5.

Table 5: Resins used in Ink-Receiving Layer and Evaluation Tests on Recording Sheets

| | | | | Bonding of | Banding of |
|---|---|---|---|---|---|
| | | Trade | Com- | reflected | transmitted |
| | Type | Name | ponent | image | image |
| Ex. 16 | Cationic | IJ50 | Modified | GOOD | GOOD |
| | | | urethane | | |
| Ex. 17 | Cationic | CM318 | Modified | GOOD | GOOD |
| | | | polyvinyl | | |
| | | | alcohol | | |
| Ex. 18 | Cationic | IJAP480 | Acrylic | GOOD | GOOD |
| | | | copolymer | | |
| Ex. 19 | Anionic | NS122L | Polyester | POOR | FAIR |
| Ex. 20 | Nonionic | PVA117 | Polyvinyl | POOR | FAIR |
| | | | alcohol | | |
| | | | (saponi- | | |
| | | | fica- | | |
| | | | tion | | |
| | | | degree: | | |
| | | | 99) | | |
| Ex. 21 | Anionic | KM118 | Modified | POOR | FAIR |
| | | | polyvinyl | | |
| | | | alcohol | | |
| Ex. 22 | Anionic | NS300L | Polyester | POOR | FAIR |
| Com. | Anionic | NS122L | Polyester | POOR | POOR |
| Ex. 6 | | | | | |

*In the above Table 5, Comparative Example 6 is conducted by adding no surfactants to the ink-permeable layer.

### COMPARATIVE EXAMPLE 6

An ink-receiving layer was formed on a substrate using the same coating solution for forming an ink-permeable layer as used in Example 16, then an ink-permeable layer was formed according to the same step as in Example 1 using the same coating solution for forming an ink-permeable layer as used in Comparative Example 5 which did not contain any sufactant, thus a recording sheet of Comparative Example 6 being obtained.

A print image was formed on this recorging sheet under the same conditions as in Example 1 to prepare a test piece. This test piece was used to conduct evaluation tests on “banding of transmitted image” and “banding of reflected image” under the same conditions as in Examples 13 to 19. Results of these evaluation tests are shown in the above Table 5.

Additionally, to categorize those cation group-containing compounds which acquire positive charge in an aqueous solution (polycations) as cationic resins, those anion group-containing compounds which acquire negative charge in an aqueous solution (polyanions) as anionic resins, and those which do not acquire electric charge in an aqueous solution as nonionic resins, the modified urethane resin used in Example 16, the modified polyvinyl alcohol used in Example 17 and the acrylic copolymer used in Example 18 are categorized as the cationic resins, the polyester used in Example 19 and the polyvinyl alcohol used in Example 20 are categorized as the nonionic resins, and the modified polyvinyl alcohol used in Example 21 and the polyester used in Example 22 are categorized as the anionic resins.

As is apparent from the above Table 5, Examples 16 to 18 wherein cationic resin was used in the ink-receiving layer 12 showed formation of reflected images and transmitted images with no banding in comparison with Examples 19 to 22 wherein anionic or nonionic resin was used, thus good results being obtained.

This may be attributed to that, in Examples 16 to 18 using the cationic resins, the cationic resins function as a fixing agent capable of fixing the ink colorant, thus ink colorant-fixing properties of the ink-receiving layer 12 being improved.

On the other hand, in Comparative Example 6 in which no surfactants were added to the ink-permeable layer, banding was observed in both the reflected image and the transmitted image.

As is described above, the recording sheets having both the ink-permeable layer 13 to which the surfactant of 9 or less in HLB value was added and the ink receiving layer 12 to which the cationic resin was added difficultly undergo formation of banding within both of the ink-receiving layer 12 and the ink-permeable layer 13, thus printed images with higher quality being confirmedly obtained.

A print sample was printed on the surface of the ink-permeable layer 13 of each of the recording sheets of Examples 1, 6, 7 and Comparative Example 5 using a pigment ink. Diameter sizes of dots formed on the surface of the ink-permeable layer (printed surface) of each of the recording sheets 10 and diameter sizes of dots formed on the side of the substrate 11 on which side the ink-receiving layer 12 and the ink-permeable layer 13 were not formed (the side to be viewed (observed)) were measured.

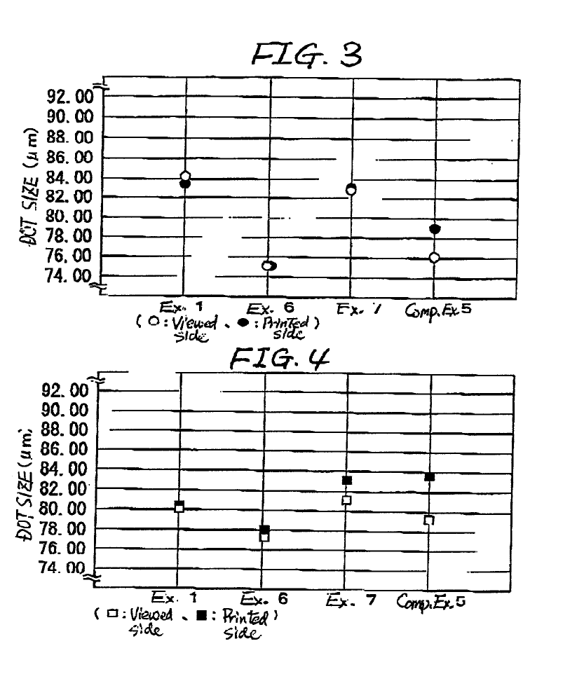

FIG. 2 shows sizes of dots formed by using a yellow pigment ink, FIG. 3 shows sizes of dots formed by using a cyan pigment ink, and FIG. 4 shows sizes of dots formed by using a magenta pigment ink, with the number on the ordinate indicating the size of dot in each of Examples and Comparative Example described on the abscissa.

As is apparent from the graphs shown in FIGS. 2 to 4, sizes of dots formed in Examples 1, 6 and 7 on the side to be viewed and on the printed side are more approximate to each other in comparison with those in Comparative Example 5. Thus, it was confirmed that the ink deposited on the ink-permeable layer 13 did not diffuse within the ink-permeable layer 13 and the ink-receiving layer 12 but straightly migrated and permeated in the depthwise direction.

Although descriptions have so far been made by reference to the case of using polyethylene terephthalate as the substrate 11, the invention is not limited to this.

As the material of the substrate 11, there may be used, for example, polyesters such as polyethylene naphthalate; polyolefins such as polyethylene and polypropylene; polyvinyl chloride; polystyrene; polymethyl methacrylate; polycarbonate; transparent paper; cellulose acetate; polyacrylate and polyether sulfone.

In particular, as a material for the substrate 11 of the recording sheet for OHP, polyethylene terephthalate, hard polyvinyl chloride, polypropylene and triacetate are preferably used.

Thickness of the substrate 11 is not particularly limited but, as a general guide, it is in the range of from 50 μm to 200 μm.

When the ink-receiving layer 12 is tough enough, it is not necessary to use the substrate 11, and the recording sheet 10 may have a 2-layered structure comprising the ink-receiving layer 12 and the ink-permeable layer 13 formed on the surface thereof.

In addition, although silica was used in the above Examples as the inorganic filler to be added to the ink-permeable layer 13, inorganic fillers of the invention are not limited only to it, and there may be used, for example, alumina sol, pseudoboehmite sol, talc, kaolin, clay, zinc oxide, tin oxide, aluminum oxide, aluminum hydroxide, calcium carbonate, titanium white, barium sulfate, titanium dioxide, aluminum silicate, magnesium silicate, magnesium oxide, smectite, zeolite and diatomaceous earth.

Further, the water-insoluble resin to be used in the ink-permeable layer 13 is not limited to polyester, and there may also be used, for example, polyethylene, polystyrene, polymethacrylate, elastomer, ethylene/vinyl acetate copolymer, styrene/acryl copolymer, polyacryl, polyvinyl ether, polyamide, polyolefin, polysilicone, guanamine, polytetrafluoroethylene, urea resin, phenoxy resin, epoxy resin and styrene/butadiene rubber.

In coating the coating solution for forming the ink-permeable layer or the ink-receiving layer of the invention, not only Meyer bar or bar coater but various other coating apparatus such as a knife coater or a gravure coater may be used as well.

The recording sheet 10 of the invention provides particularly excellent printing results when a pigment ink is used, but the invention is not limited only to this. The recording sheet of the invention permits to conduct printing using a dye ink as well as a pigment ink.

As has been described hereinbefore, the invention provides a recording sheet which enables to form printed images with scarce banding and excellent color density.

Although the invention has been described with respect to specific embodiments, the details are not to be construed as limitations, for it will become apparent that various embodiments, changes and modifications may be resorted to without departing from the spirit and scope thereof, and it is understood that such equivalent embodiments are intended to be included within the scope of this invention.

The entire disclosure of each and every foreign patent application from which the benefit of foreign priority has been claimed in the present application is incorporated herein by reference, as if fully set forth herein.

What is claimed is:

1. A recording sheet comprising:
an ink-receiving layer capable of holding an ink; and
an ink-permeable layer provided on the surface of the ink-receiving layer and permeating the ink therethrough to transport the ink to the ink-receiving layer,
wherein the ink-permeable layer comprises a surfactant having an HLB value of 9 or less.

2. The recording sheet according to claim 1, wherein the ink-permeable layer further comprises a water-insoluble resin.

3. The recording sheet according to claim 2, wherein the water-insoluble resin is a polyester.

4. The recording sheet according to claim 1, wherein the ink-receiving layer further comprises a cation group-containing compound.

5. The recording sheet according to claim 2, wherein the ink-receiving layer further comprises a cation group-containing compound.

6. The recording sheet according to claim 3, wherein the ink-receiving layer further comprises a cation group-containing compound.

7. The recording sheet according to claim 4, wherein the cation group-containing compound is a cation group-containing resin.

8. The recording sheet according to claim 5, wherein the cation group-containing compound is a cation group-containing resin.

9. The recording sheet according to claim 6, wherein the cation group-containing compound is a cation group-containing resin.

10. The recording sheet according to claim 4, wherein the ink-receiving layer further comprises a hydrophilic fixing aid comprising a resin different from the fixing agent.

11. The recording sheet according to claim 7, wherein the ink-receiving layer further comprises a hydrophilic fixing aid comprising a resin different from the fixing agent.
